(19) United States
(12) Patent Application Publication
(10) Pub. No.: US 2013/0162008 A1
(43) Pub. Date: Jun. 27, 2013

(54) WHEEL RIM STRUCTURE

(71) Applicant: Mu-Rong Li, Taichung City (TW)

(72) Inventor: Mu-Rong Li, Taichung City (TW)

(21) Appl. No.: 13/655,458

(22) Filed: Oct. 19, 2012

(30) Foreign Application Priority Data
Dec. 23, 2011 (TW) 100224446

(51) Int. Cl. B60B 1/04

(52) U.S. Cl. 301/58

(57) ABSTRACT

A wheel rim structure includes a rim body having a plurality of assembling grooves equidistantly defined along an inner periphery thereof, each assembling groove having a receiving space defined at one end thereof and a positioning space defined at another end thereof, the receiving space communicating with the positioning space, a plurality of spokes having a connecting end formed at one end thereof and having a positioning block which is adjacent to the connecting end, a wheel hub having a plurality of second connecting holes equidistantly opened thereon. Under this arrangement, the connecting end is assembled into the receiving space and the positioning block is locked at the positioning space; another end of the spokes is assembled into the second connecting hole. Therefore, the spoke could be easily detached from the rim body or be easily assembled to the rim body via the assembling groove.

### BACKGROUND OF THE INVENTION

1. Field of the Invention

The present invention relates to a wheel rim and more particularly to a wheel rim structure, in which a spoke could be easily detached from a rim body or be easily assembled to the rim body.

2. Description of Related Art

Bicycle activity is more and more popular in the 21st century because bicycle activity is eco-friendly, convenient and entertaining. Many enterprises encourage their employees to go to work by bicycles instead of driving vehicles today. Many people also go shopping or go traveling by bicycles during their leisure time. After the long term riding, the wheel rims of the bicycle are often easily to get broken. Therefore, how to provide a wheel rim structure for quickly repairing becomes an important topic when a wheel rim manufacturer designs and produces wheel rims.

Generally, a conventional wheel rim structure comprises a rim body, a plurality of spokes and a wheel hub. The rim body has an inner periphery and an outer periphery formed thereon. A plurality of through holes is opened around the inner periphery of the rim body therethrough. Each of spokes has a first end and a second end defined at two ends thereof. The second end of the spoke is threaded. The wheel hub is located at the inner center of the rim body. The first ends of the spokes are respectively and equidistantly connected along the periphery of the wheel hub. The second ends of the spokes are respectively passing through the through holes. Thereafter, a screw nut is being screwed onto the second end of each spoke until the screw nut is fastened on the spokes tightly. Under this arrangement, each of spokes is connected between the wheel hub and the rim body firmly. Finally, a tire encircling the rim body is assembled on the outer periphery of the rim body.

However, the conventional wheel rim structure has two disadvantages as following:

First, a user must release the tire from the rim body inconveniently when the spoke is broken and the user wants to replace the broken spoke, because the screw nuts corresponding to the broken spoke are covered by the tire and the user must loosen the screw nuts so as to detach the broken spoke from the rim body.

Second, the user needs tools when the user is loosening the screw nuts. In the other word, the user must have the tools to repair when the spokes is broken.

The present invention has arisen to mitigate and/or obviate the disadvantages of the conventional. Further benefits and advantages of the present invention will become apparent after a careful reading of the detailed description with appropriate reference to the accompanying drawings.

### SUMMARY OF THE INVENTION

The main objective of the present invention is to provide an improved wheel rim structure.

To achieve the objective, a wheel rim structure comprises a rim body, a plurality of assembling grooves equidistantly defined along an inner periphery of the rim body, referring to each two neighbor assembling grooves, one assembling groove is opened on one side of the rim body and another assembling groove is opened on another side of the rim body, each assembling groove having a receiving space defined at one end thereof and having a positioning space defined at another end thereof, the receiving space communicating with the positioning space, a plurality of spokes, a connecting end formed at one end of the spoke, the spoke having a positioning block which is adjacent to the connecting end, the positioning block corresponding to the positioning space, the connecting end assembled into the receiving space and the positioning block locked at the positioning space, a wheel hub, the wheel hub having a first hub flange formed at one end thereof and having a second hub flange formed at another end thereof, a plurality of second connecting holes equidistantly opened around the first hub flange and the second hub flange, each of second connecting holes of the first hub flange and the second hub flange corresponding to another end of the corresponding spokes which have been connected to the corresponding assembling grooves at one end thereof, another end of the corresponding spokes assembled into the second connecting hole. Wherein the wheel rim structure further comprises a plurality connectors, the connector having a first threaded end foamed at one end thereof and having a second threaded end formed at another end thereof, the first threaded end screwed into a first sleeve and the second threaded end screwed into a second sleeve, a first connecting hole opened at another end of the spoke, the first sleeve assembled into the first connecting hole, the second sleeve assembled into the second connecting hole; a middle part of the spoke is formed between the positioning block and the first connecting hole; the middle part is a flat bar; the rim body is made from carbon fibers; the shape of the connecting end is corresponding to the shape of the assembling groove; the connecting end is ball-shaped; the cross-section of the assembling groove is circle-shaped; each of second connecting holes of the first hub flange and the second hub flange are corresponding to the corresponding assembling grooves; each two neighbor spokes are crossing; one spoke is connected between the assembling groove opened on one side of the rim body and the second connecting hole opened on the second hub flange; the next spoke is connected between the assembling groove opened on another side of the rim body and the second connecting hole opened on the first hub flange; the second connecting holes are radially arranged on the lateral of the first hub flange; the second connecting holes are radially arranged on the lateral of the second hub flange.

Thereby, the spoke could be easily detached from the rim body or be easily assembled to the rim body via the assembling groove.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view for showing the first embodiment of a wheel rim structure of the present invention;

FIG. 2 is a perspective view for showing the second embodiment of the wheel rim structure of the present invention;

FIG. 3 is a perspective view of the second embodiment for showing a rim body of the wheel rim structure;

FIG. 4 is a partially exploded view of the second embodiment for showing a connector which is connecting between a spoke and a wheel hub;

FIG. 5 is a partially exploded view of the second embodiment for showing the spoke which is connecting between the rim body and the connector;

FIG. 6 is a cross-sectional view for showing the second embodiment;

FIG. 6A is a partially enlarged cross-sectional view for showing the connector which has been connected between the spoke and the wheel hub;

FIGS. 6B-6C are partially enlarged cross-sectional views for showing a connecting end which is assembled into an assembling groove; and

FIGS. 7-8 are partially enlarged cross-sectional views for showing the connecting end which is not assembled into the assembling groove.

### DETAILED DESCRIPTION OF THE INVENTION

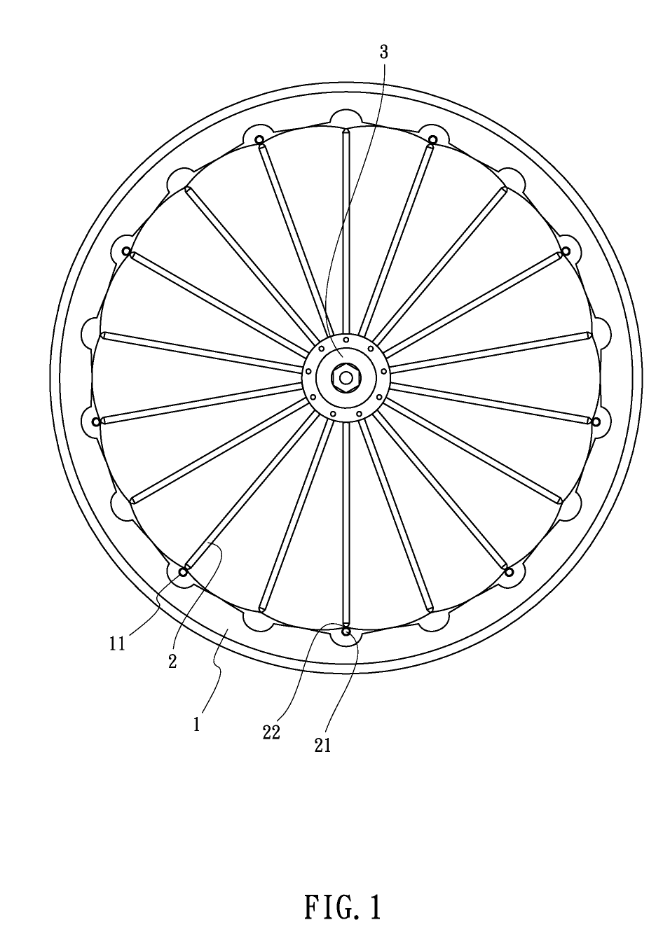

Referring to FIG. 1, a wheel rim structure in accordance with the present invention comprises a rim body 1, a plurality of spokes 2 and a wheel hub 3. The rim body 1 is made from carbon fibers. A plurality of assembling grooves 11 is equidistantly defined along an inner periphery of the rim body 1. Referring to each two neighbor assembling grooves 11, one assembling groove 11 is opened on one side of the rim body I and another assembling groove 11 is opened on another side of the rim body 1. A connecting end 21 is formed at one end of the spoke 2. The shape of the connecting end 21 is corresponding to the shape of the assembling groove 11. The connecting end 21 is ball-shaped, The cross-section of the assembling groove 11 is circle-shaped. The spoke 2 has a positioning block 22 which is adjacent to the connecting end 21. The positioning block 22 is cube-shaped in this embodiment. The connecting end 21 is assembled into the assembling groove 11 for connecting the spoke 2 to the rim body 1. The positioning block 22 is receiving in the assembling groove 11 for making the connection between the spoke 2 and the rim body 1 stable. Another end of each spoke 2 is respectively connected to the wheel hub 3. Referring to each two neighbor spokes 2, one spoke 2 is connected between the wheel hub 3 and the assembling groove 11 which is opened on one side of the rim body 1. Another spoke 2 is connected between the wheel hub 3 and the assembling groove 11 which is opened on another side of the rim body 1.

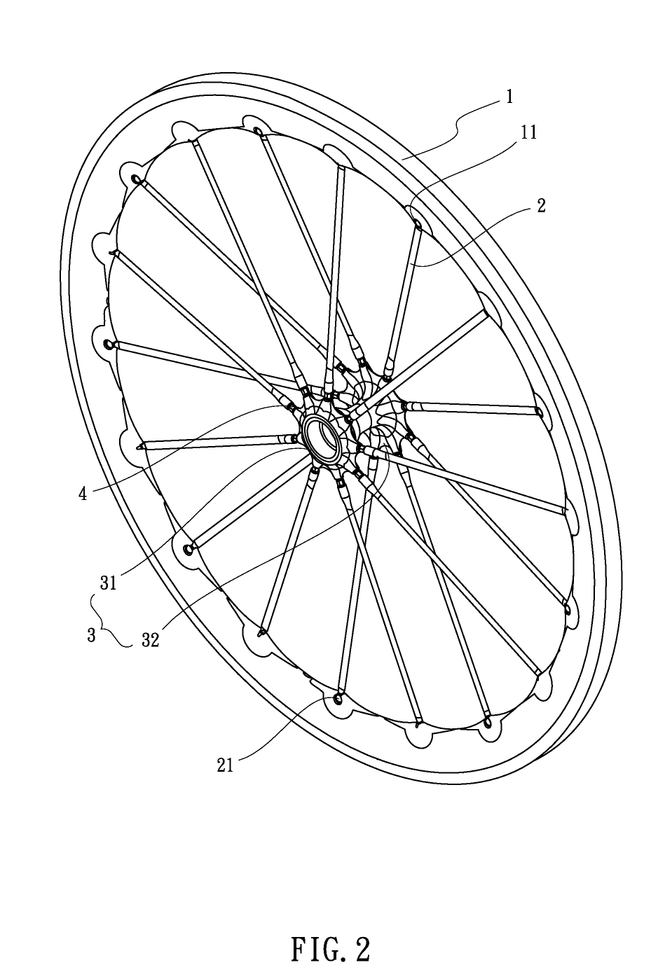

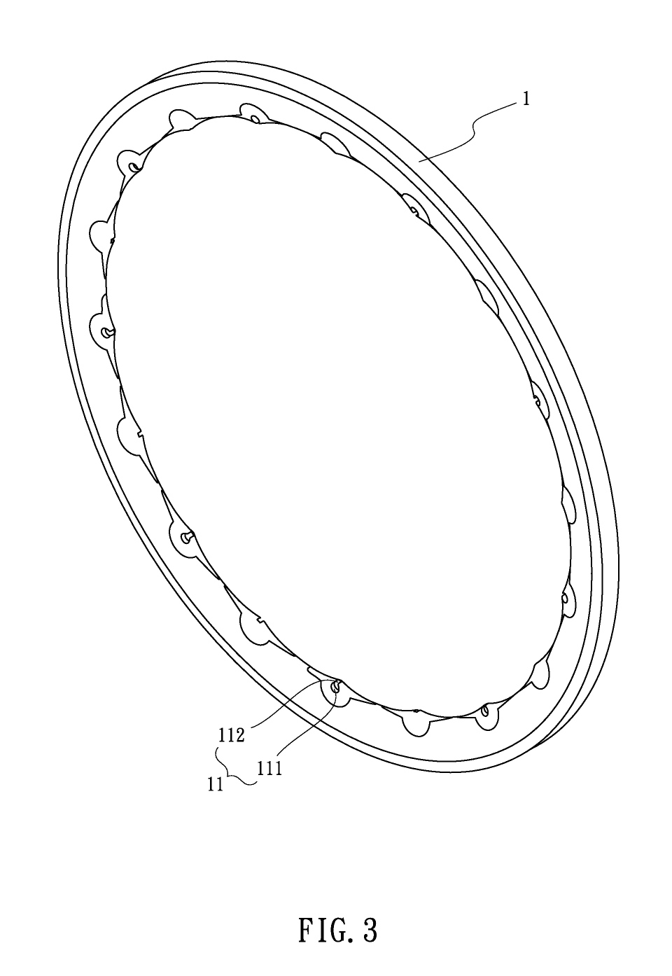

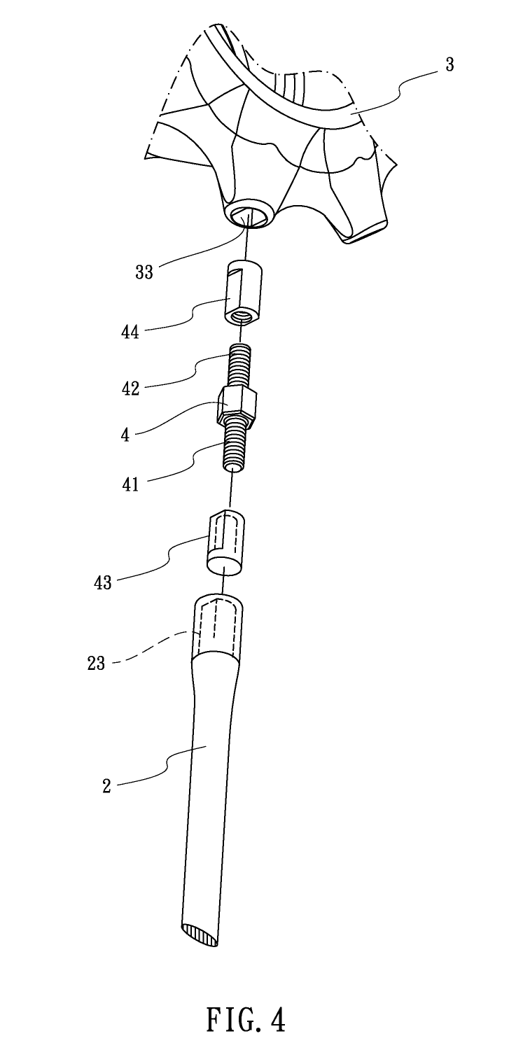

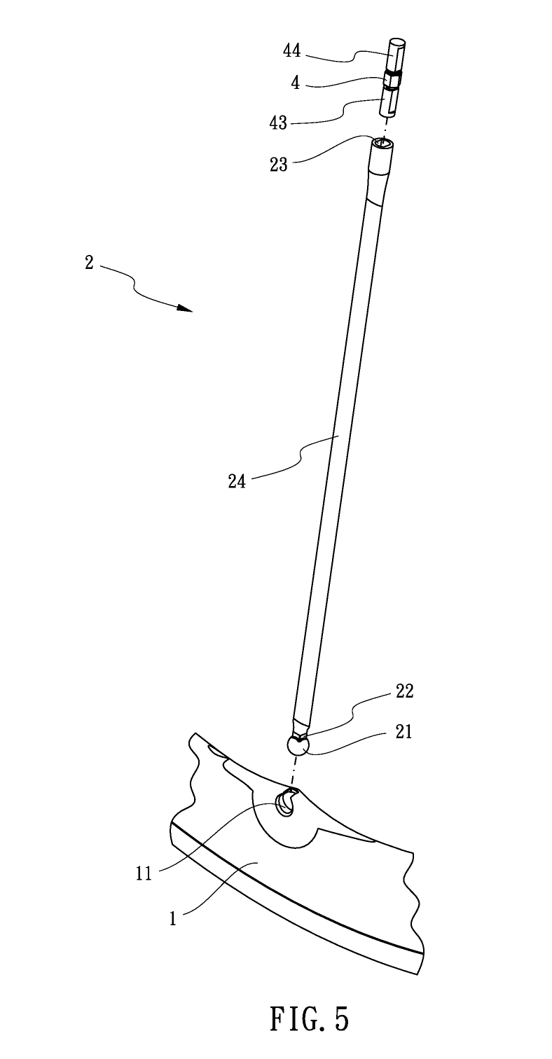

Referring to FIGS. 2-6A, the second embodiment of the wheel rim structure in accordance with the present invention comprises a rim body 1, a plurality of spokes 2, a wheel hub 3 and a plurality of connectors 4. The rim body 1 is made from carbon fibers. A plurality of assembling grooves 11 is equidistantly defined along an inner periphery of the rim body 1. Referring to each two neighbor assembling grooves 11, one assembling groove 11 is opened on one side of the rim body 1 and another assembling groove 11 is opened on another side of the rim body 1. Each assembling groove 11 has a receiving space 111 defined at one end thereof and has a positioning space 112 defined at another end thereof. The receiving space 111 communicates with the positioning space 112. A connecting end 21 is formed at one end of the spoke 2. The shape of the connecting end 21 is corresponding to the shape of the assembling groove 11. The connecting end 21 is ball-shaped. The cross-section of the assembling groove 11 is circle-shaped. The spoke 2 has a positioning block 22 which is adjacent to the connecting end 21. The positioning block 22 is cube-shaped in this embodiment. The positioning block 22 is corresponding to the positioning space 112. The connecting end 21 is assembled into the receiving space 111 and the positioning block 22 is locked at the positioning space 112 so that the one end of the spoke 2 is connected to the rim body 1 firmly. The connector 4 is assembled to another end of the spoke 2. The connector 4 has a first threaded end 41 formed at one end thereof and has a second threaded end 42 formed at another end thereof. The first threaded end 41 is screwed into a first sleeve 43 and the second threaded end 42 is screwed into a second sleeve 44. A first connecting hole 23 is opened at another end of the spoke 2. The first sleeve 43 is assembled into the first connecting hole 23. The wheel hub 3 has a first hub flange 31 formed at one end thereof and has a second hub flange 32 formed at another end thereof. A plurality of second connecting holes 33 is equidistantly opened around the first hub flange 31 and the second hub flange 32. The second connecting holes 33 are radially arranged on the lateral of the first hub flange 31. The second connecting holes 33 are radially arranged on the lateral of the second hub flange 32. Each of second connecting holes 33 of the first hub flange 31 and the second hub flange 32 are corresponding to the corresponding assembling grooves 11 and are further corresponding to another end of the spokes 2 which have been connected to the corresponding assembling grooves 11 at one end thereof. The second sleeve 44 is assembled into the second connecting hole 33. Under this arrangement, each two neighbor spokes 2 are crossing; one spoke 2 is connected between the assembling groove 11 opened on one side of the rim body 1 and the second connecting hole 33 opened on the second hub flange 32; the next spoke 2 is connected between the assembling groove 11 opened on another side of the rim body 1 and the second connecting hole 33 opened on the first hub flange 31. Consequently, the rim body 1 could be rotated by the rotation of the wheel hub 3.

Furthermore, a middle part 24 of the spoke 2 is formed between the positioning block 22 and the first connecting hole 23. The middle part 24 is a flat bar.

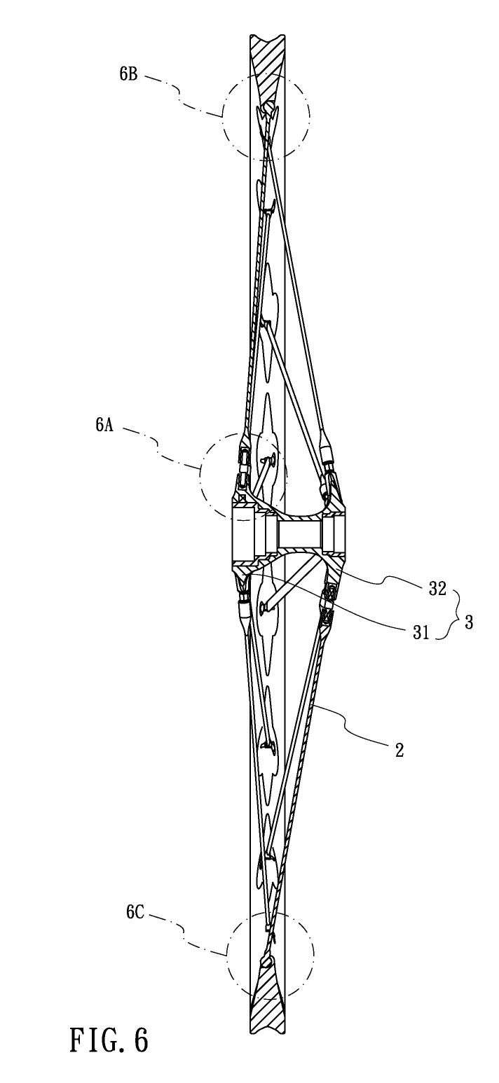

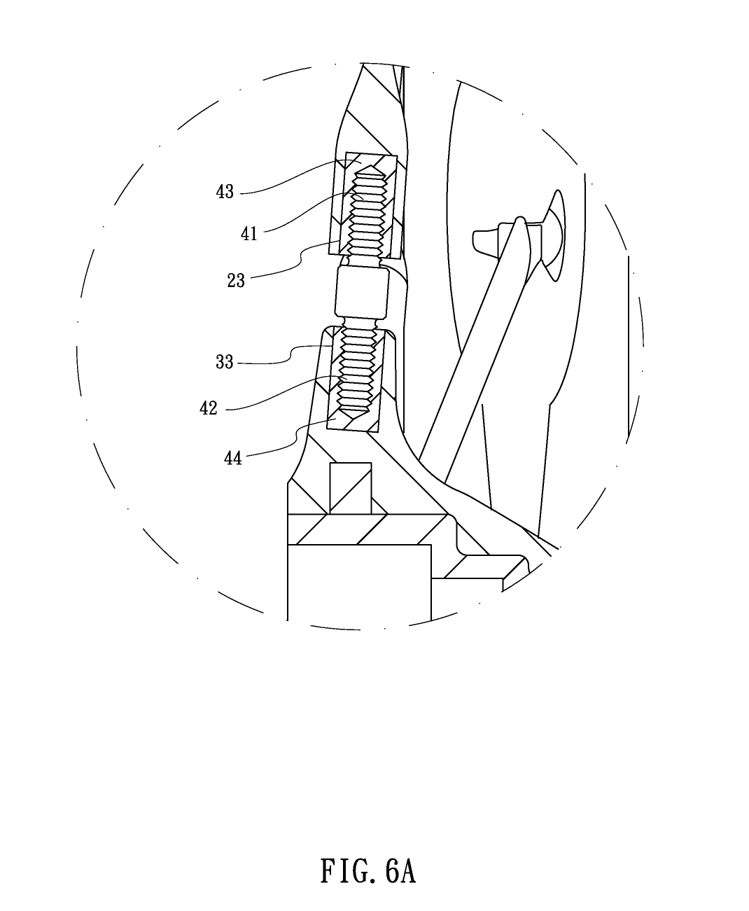

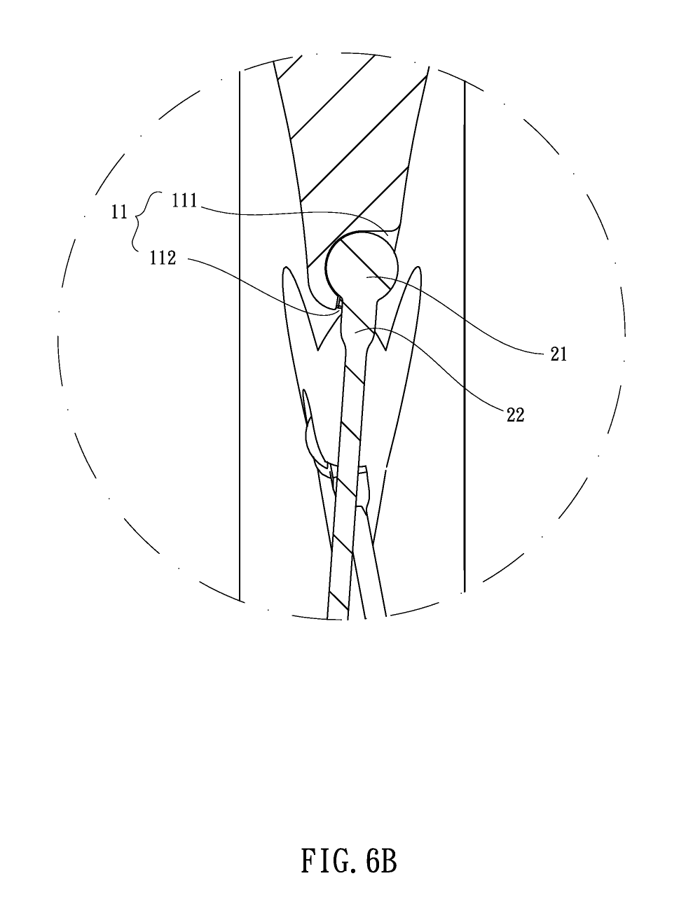

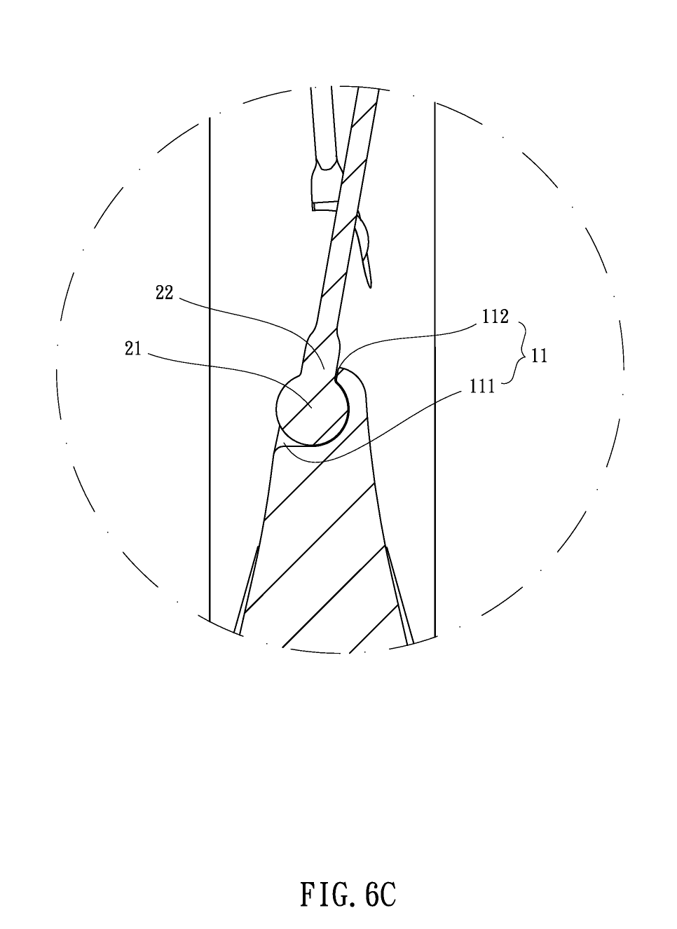

Referring to FIGS. 6B-6C, when the connecting end 21 and the positioning block 22 of the spoke 2 are assembled into the assembling groove 11, the connecting end 21 is received in the receiving space 111 and the positioning block 22 is locked at the positioning space 112.

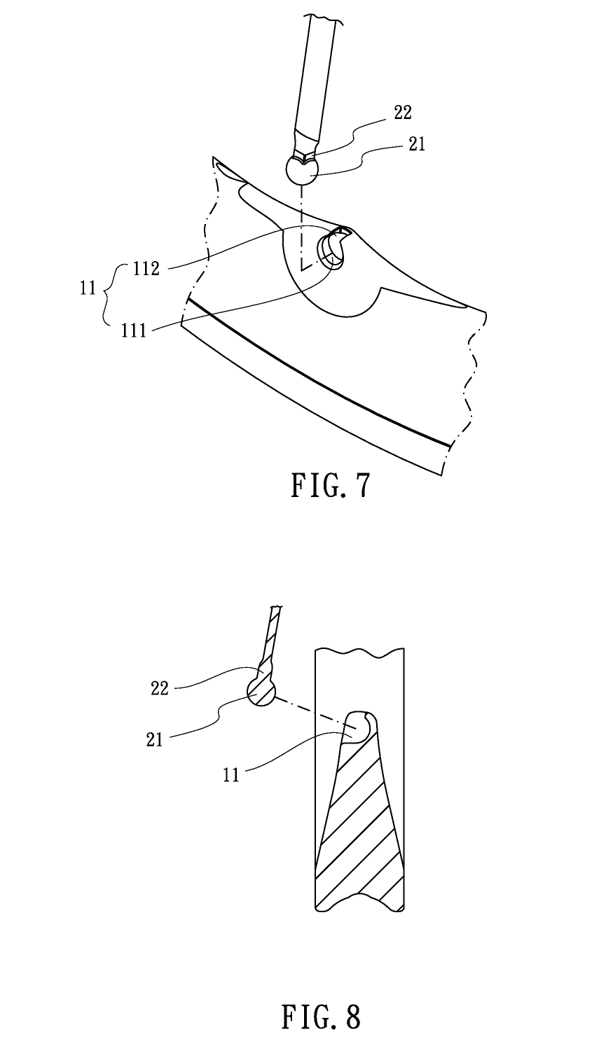

Referring to FIGS. 7-8, when a user wants to detach the spoke 2 from the rim body 1, the user pulls out the positioning block 22 from the positioning space 112 and pulls out the connecting end 21 from the receiving space 111 at first, and then the user separates the first sleeve 43 from the first connecting hole 23 of the spoke 2. In contrast, when the user wants to assemble the spoke 2 to the rim body 1, the user inserts the first sleeve 43 into the first connecting hole 23 of the spoke 2 at first, and then the user assembles the connecting end 21 into the receiving space 111 and pushes the positioning block 22 into the positioning space 112 until the positioning block 22 is locked at the positioning space 112.

All in all, the spoke 2 could be easily released from the rim body 1 or be easily assembled to the rim body 1 via the assembling groove 11 and the connector 4.

Although the invention has been explained in relation to its preferred embodiment, it is to be understood that many other possible modifications and variations can be made without departing from the spirit and scope of the invention as hereinafter claimed.

What is claimed is:

1. A wheel rim structure comprising:
a rim body, a plurality of assembling grooves equidistantly defined along an inner periphery of the rim body, referring to each two neighbor assembling grooves, one assembling groove is opened on one side of the rim body and another assembling groove is opened on another side of the rim body, each assembling groove having a receiving space defined at one end thereof and having a positioning space defined at another end thereof, the receiving space communicating with the positioning space;
a plurality of spokes, a connecting end formed at one end of the spoke, the spoke having a positioning block which is adjacent to the connecting end, the positioning block corresponding to the positioning space, the connecting end assembled into the receiving space and the positioning block locked at the positioning space; and
a wheel hub, the wheel hub having a first hub flange formed at one end thereof and having a second hub flange formed at another end thereof, a plurality of second connecting holes equidistantly opened around the first hub flange and the second hub flange, each of second connecting holes of the first hub flange and the second hub flange corresponding to another end of the corresponding spokes which have been connected to the corresponding assembling grooves at one end thereof, another end of the corresponding spokes assembled into the second connecting hole;
thereby, the spoke could be easily detached from the rim body or be easily assembled to the rim body via the assembling groove.

2. The wheel rim structure as claimed in claim 1, wherein the wheel rim structure further comprises a plurality connectors, the connector having a first threaded end formed at one end thereof and having a second threaded end formed at another end thereof, the first threaded end screwed into a first sleeve and the second threaded end screwed into a second sleeve, a first connecting hole opened at another end of the spoke, the first sleeve assembled into the first connecting hole, the second sleeve assembled into the second connecting hole.

3. The wheel rim structure as claimed in claim 2, wherein a middle part of the spoke is formed between the positioning block and the first connecting hole; the middle part is a flat bar.

4. The wheel rim structure as claimed in claim 1, wherein the rim body is made from carbon fibers.

5. The wheel rim structure as claimed in claim 1, wherein the shape of the connecting end is corresponding to the shape of the assembling groove.

6. The wheel rim structure as claimed in claim 5, wherein the connecting end is ball-shaped; the cross-section of the assembling groove is circle-shaped.

7. The wheel rim structure as claimed in claim 1, wherein each of second connecting holes of the first hub flange and the second hub flange are corresponding to the corresponding assembling grooves.

8. The wheel rim structure as claimed in claim 1, wherein each two neighbor spokes are crossing; one spoke is connected between the assembling groove opened on one side of the rim body and the second connecting hole opened on the second hub flange; the next spoke is connected between the assembling groove opened on another side of the rim body and the second connecting hole opened on the first hub flange.

9. The wheel rim structure as claimed in claim 1, wherein the second connecting holes are radially arranged on the lateral of the first hub flange.

10. The wheel rim structure as claimed in claim 1, wherein the second connecting holes are radially arranged on the lateral of the second hub flange.
